(19) United States
(12) Patent Application Publication
(10) Pub. No.: US 2023/0314192 A1
(43) Pub. Date: Oct. 5, 2023

(54) MICROWAVE RESONANT CAVITY TRANSDUCER FOR HIGH TEMPERATURE FLUID FLOW SENSING

(71) Applicant: UCHICAGO ARGONNE, LLC, Chicago, IL (US)

(72) Inventors: Alexander Heifetz, Riverwoods, IL (US); Sasan Bakhtiari, Darien, IL (US)

(21) Appl. No.: 17/710,341

(22) Filed: Mar. 31, 2022

(51) Int. Cl. G01F 1/34

(52) U.S. Cl. CPC G01F 1/34

(57) ABSTRACT

Monitoring fluid flow of high temperature materials is required across a wide range of applications. A device for performing flow measurements of high temperature materials includes a resonant chamber having at least one inner surface forming a hollow resonant cavity. A deformable membrane has a first side forming a wall of the hollow resonant cavity, and a second side in contact with an external environment in which the resonant chamber is disposed. A waveguide is physically coupled to the resonant cavity, with the waveguide configured to provide to the resonant chamber a band of wavelengths of radiation.

### STATEMENT REGARDING FEDERALLY SPONSORED RESEARCH OR DEVELOPMENT

This invention was made with government support under Contract No. DE-ACO2-06CH11357 awarded by the United States Department of Energy to UChicago Argonne, LLC, operator of Argonne National Laboratory. The government has certain rights in the invention.

### FIELD OF THE DISCLOSURE

The present disclosure relates to methods and systems for measuring flow of high temperature fluids, and specifically to determining fluid velocity using a resonant microwave metallic cavity.

### BACKGROUND

Monitoring fluid flow through pipes, tanks, and other apparatuses is important for a variety of industries including oil and gas supply and refinery, nuclear energy and reactors, pharmaceuticals, water and waste systems, food and beverage, textiles, manufacturing plants, and others. Accurate flow rate measurement is required to ensure fluid control processes run according to design. Systems that have errors in fluid velocity can cause structural and mechanical failures, which may lead to leakages of fluid which may create unsafe operation conditions, and further cause damage to the system. Therefore monitoring fluid flow is valuable for system safety and further prevents damages which reduces potential repair time and costs.

Fluid flow monitoring of high temperature fluids (i.e., greater than 100° C.) provides additional challenges in measuring fluid velocity. For example, high-temperature fluid nuclear reactors, such as sodium fast reactors (SFR) and molten salt cooled reactors (MSCR), are examples of reactors with highly-efficient thermal energy conversion cycle requiring precise monitoring of fluid velocities. Measurement of high-temperature fluid processes and velocities, in particular fluid flow inside a pressure vessel of a reactor, is challenging due to the harsh environments of the reactors. For example, fluid flow monitoring devices for reactors are often in close proximity to radiation, high temperatures, and often require physical contact with highly corrosive materials such as coolant fluids. Therefore, many fluid flow sensors are incapable of being used in measuring fluid flow of reactor systems, or have short operational lifetimes due to damage caused by exposed radiation and/or corrosion.

Molten metal flow is another example of a high temperature fluid flow that requires precise real-time measurements of fluid velocity. Liquid metal and molten salt flow sensors typically include a Venturi flow sensor, magnetic flow sensor, or ultrasonic flow sensor. Magnetic flow meters employ high-temperature permanent magnets, or flux measurement coils, to measure the rate of conducting flux passing through coil cross-sections or through a nearby pipe. The permanent magnets are made from heavy materials that have a temperature dependent magnetic field output that drifts with time. The drift is hard to predict and therefore requires additional monitoring or frequent system recalibration. Some drawbacks of coil-based magnetic flow meters include requiring large and heavy power supplies, providing a temperature dependent output, exhibiting nonlinear magnetic behavior at large currents and magnetic field strengths, and dependence on specific flow profiles for obtaining accurate measurements.

Venturi flow meters require extensive real estate due to long installation lengths and further depend on specific flow profiles for measurement accuracy. Further, Venturi flow meters provide very poor flow measurement precision at low flow velocities. Ultrasonic flow meters are based on detecting either a time-of-flight measurement or Doppler frequency shift of acoustic waves in pitch-and-catch or transmission-based configurations. Typically, ultrasonic transducers are placed outside of a vessel containing the fluid flow. However, ultrasonic sensors require a direct line-of-sight between transducers which reduces system robustness and requires specific placement of transducer limiting form factors and physical layout designs of the system. In addition, ultrasonic flowmeters are sensitive to fluid flow profiles in single path configurations, and multipath arrangements require complex signal processing. Additionally, differential pressure measurement methods require two or more transducers which results in bulky setups requiring a number of extra components.

As described, current high-temperature fluid flow meters have a number of drawbacks including, without limitation, fluid flow profile dependent measurements, large form factors, heavy components, limited operational lifetime, and limited form factors and physical arrangements of components. Therefore, there is need for a lighter-weight, more compact, robust and resilient high-temperature fluid flow meter.

### SUMMARY OF THE DISCLOSURE

In an embodiment, disclosed is a flow measurement device. The device includes a resonant chamber defined by an inner surface of a hollow resonant cavity. A deformable membrane has a first side forming a wall of the hollow resonant cavity, and a second side in contact with an external environment in which the resonant chamber is disposed. A waveguide is physically coupled to the resonant cavity, the waveguide configured to provide to the resonant chamber a band of wavelengths of microwave (MW) radiation. A variation of the current embodiment further includes a radiation source operatively coupled to the waveguide, the radiation source being configured to provide radiation to the waveguide. In the current variation, a detector is operatively coupled to the waveguide, the detector configured to receive radiation from the waveguide, and a radiation circulator is operatively coupled to the radiation source, the waveguide, and the detector. The radiation circulator is configured to (i) receive radiation from the radiation source, (ii) provide radiation to the waveguide, (iii) receive radiation from the waveguide, and (iv) provide radiation to the detector. In variations of the current embodiment, the radiation source is a microwave radiation source.

In an embodiment, disclosed is a method for performing a flow measurement of a fluid. The method includes disposing, in a fluid flow, a flow measurement device according to the embodiment of the previous paragraph, the flow measurement device being disposed such that the fluid flow is orthogonal to the deformable membrane. The method further includes providing fluid flow against a deformable membrane and providing, from a radiation source, radiation to the resonant cavity at a resonant frequency. A radiation detector then detects radiation from the resonant cavity and provides a signal indicative of the detected radiation to a processor. The processor determines a change in the resonant frequency of the resonant cavity, and further determines a fluid flow rate from the change in the resonant frequency. In a variation of the current embodiment, the radiation source is a microwave source, and the waveguide is a microwave waveguide.

### BRIEF DESCRIPTION OF THE DRAWINGS

FIG. 1A is a cut-away perspective view of a resonant chamber demonstrating physical concepts for performing high-temperature fluid flow measurements as described herein.

FIG. 1B is a cut-away perspective view of a resonant chamber demonstrating physical concepts for performing high-temperature fluid property measurements as described herein.

FIG. 2A is a cut-away side view of a resonant chamber illustrating deflection of a deformable membrane due to a force applied by fluid flow against the deformable membrane.

FIG. 2B is a simulated plot of deflection versus radial position across the deformable membrane of FIG. 2A.

FIG. 3A is a plot of a TM₀₁₁ electromagnetic spatial mode inside of a cylindrical cavity.

FIG. 3B is a plot of frequency shift of the resonant cavity of FIG. 3A due to a 500° C. fluid flow provided against the deformable membrane.

FIG. 4A is a modal map of a TE₀₁₁ spatial mode in a resonant cavity without deformation of a deformable membrane.

FIG. 4B is a plot of resonant frequency shifts of the TE₀₁₁ mode of FIG. 4A, for a range of fluid flow velocities.

FIG. 5A is a modal map of a TE₀₁₂ spatial mode in a resonant cavity.

FIG. 5B is a plot of the resonant frequency shift of a deformable membrane under pressure from a 500° C. flow of liquid sodium with flow velocities from 0.5 m/s to 2 m/s.

FIG. 6A is a perspective view of a flow sensor for performing high-temperature fluid flow velocity measurements.

FIG. 6B is a perspective view of a flow sensor for performing high-temperature fluid flow velocity measurements with an alternately polarized waveguide and circulator.

FIG. 7A is a perspective view of the resonant chamber of FIG. 6.

FIG. 7B is an exploded view of the resonant chamber of FIG. 6.

FIG. 8A is a schematic diagram of a fluid flow measurement system for performing fluid flow measurements in an operational environment.

FIG. 8B is a flow diagram of a method for performing a fluid flow measurement as performed by the system of FIG. 8A.

FIG. 9A is a plot of detected radiation power spectra of reflected radiation from the resonant chamber with no fluid flow and with 40 gallons per minute fluid flow provided against a deformable membrane.

FIG. 9B is a plot of resonant frequency shift of a resonant cavity versus fluid flow speed.

FIG. 10A is a first perspective view of a deformable membrane as a circular disk.

FIG. 10B is a second perspective view of the deformable membrane of FIG. 10A.

FIG. 11A is a plot of calculated maximum stress at a radial boundary of the deformable membrane of FIGS. 10A and 10B for a fluid flow velocity of 1 m/s.

FIG. 11B is a plot of calculated maximum stress at a radial boundary of the deformable membrane of FIGS. 10A and 10B for a fluid flow velocity of 0.5 m/s.

### DETAILED DESCRIPTION

Measurement of high-temperature fluid process variables, such as fluid velocity and fluid flow inside of pipes and pressure vessels, is challenging because most conventional fluid sensors are not compatible with high temperatures, harsh operational environments, intense radiation, and coolants that are highly corrosive. Disclosed is a microwave cavity-based transducer for performing high-temperature fluid flow measurements capable of measuring flow velocities of fluids at high temperatures (e.g., above 100° C., and above 400° C. in instances). The transducer device may also be used for measuring other properties such as fluid temperature, a hydrostatic pressure, a fluid fill amount in a vessel, a pressurization amount of the fluid, or fluid density. In addition, the fluid may be a liquid or gaseous fluid. The disclosed device can be fabricated from stainless steel, and which is resilient to radiation, high temperatures, and corrosive environments such as that of reactors and corrosive coolant flows.

The high-temperature fluid flow measurement device disclosed herein determines fluid flow from deformation of a membrane due to pressure exerted against the membrane. Membrane deformation causes a volume change of a resonant cavity, and thus a shift in a resonant frequency of the cavity. A frequency sweep is provided to the cavity, and the resonant frequency, and a shift of the resonant frequency, are then determined. A fluid flow velocity is determined from the shift of the resonant frequency. In the described methods, no electronics are placed inside of the fluid flow sensor, and electronic components may be placed far from the sensor which is advantageous for applications in high temperature and high radiation environments. Because the described resonant cavity fluid flow sensing is based on fluid-structure interactions, as opposed to fluid electrical conductivity, the proposed sensor is equally applicable to liquid sodium and molten salt flow sensing.

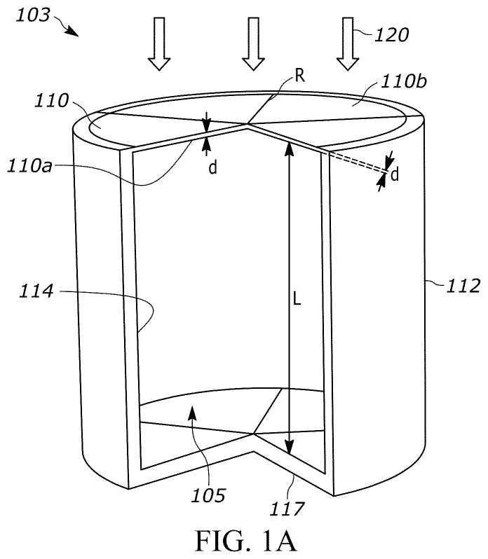

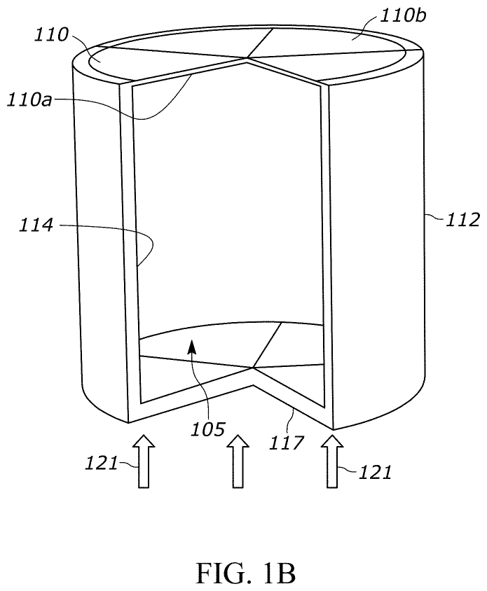

FIG. 1 is a cut-away perspective view of a resonant chamber 103 for demonstrating the physical concepts for performing high-temperature fluid flow measurements as described herein. The resonant chamber 103 has an external surface 112, and with a portion of the resonant chamber 103 removed to illustrate a resonant cavity 105 of the resonant chamber 103. The resonant cavity 105 is defined by an inner surface 114 of the resonant chamber 103. A deformable membrane 110 defines another wall of the resonant chamber 105. The deformable membrane 110 has a first surface 110a that faces the resonant cavity 105, and a second surface 110b opposite the first surface 110a, with the second surface 110b being in contact with an external environment in which the resonant chamber 103 is disposed. In operation, the resonant chamber 103 is placed in a fluid flow 120, with the fluid flow 120 being in a direction orthogonal to the second surface 110b of the deformable membrane 110. The fluid flow 120 need not be perfectly orthogonal to the second surface 110b, but the resonant chamber 103 must be placed in the fluid flow 120 at an orientation such that the fluid flow 120 provides a pressure against the second surface 110b of the deformable membrane 110. The deformable membrane 110 deforms according to the pressure applied by the fluid flow 120. As such, the deformable membrane 110 is made of a material, with a thickness d, that allows for the deformable membrane 110 to deform due to the fluid flow 120. For example, the deformable membrane 10 may be made of one or more of stainless steel, brass, or Inconel® alloy or alloys such as Inconel® alloy 718. Other metals and materials may be used for the deformable membrane 10 for systems with lower temperature fluid flows (i.e., less than 400° C.) and for non-corrosive environments. For example, brass may be useful for performing lower temperature fluid flow measurements as it does not readily oxidize as compared to other materials.

The deformable membrane 110 may have a thickness of between 5 and 10 mil, between 10 and 15 mil, between 1 and 10 mil, between 10 and 20 mil, between 1 and 20 mil, of 5 mil, 8 mil, 10 mil, less than 30 mil, or less than 50 mil. Additionally, the deformable membrane 110 may have a radius of between 1 and 10 mm, 10 and 20 mm, 20 and 30 mm, 30 and 50 mm, less than 10 mm, less than 20 mm, less than 30 mm, or less than 50 mm. For some examples described herein, the deformable membrane 110 has a thickness of 0.28 mm (11.1 mil). The thickness of the deformable membrane 110 may be determined based on the radius of the deformable membrane 110 to ensure that the deformable membrane 110 is not too fragile resulting in a rupture of the deformable membrane 110, and to ensure that the deformable membrane 110 deforms adequately to provide a sensitive flow velocity measurement. The thickness of the deformable membrane 110 may be determined based on a maximum temperature of the fluid flow 120, a maximum pressure provided by the fluid flow 120 to the deformable membrane 110, and/or a desired amount of fluid flow measurement resolution (e.g., between 5 and 60 gallons per minute (gpm), and possibly below 5 gpm). Further, the thickness of the deformable membrane 110 may depend on the radius of the deformable membrane, and a desired amount of deflection or displacement. For example, a deflection of 1 micron may be required to perform a fluid flow measurement, and the thickness of the deformable membrane 110 may then be determined from the requirements of one micron deflection, and the radius of the membrane 110. The radius of the membrane may be determined based on a desired size of the overall chamber 103 for disposing the chamber 103 in a vessel or pipe. In specific embodiments, the thickness and radius of the deformable membrane are selected such that the deformable membrane has a deflection distance between 0.5 and 5 μm.

The resonant chamber 103 in FIG. 1 is illustrated as a cylinder with the deformable membrane 110 forming a top wall, and further including a bottom wall 117 of the cylinder. In embodiments, the resonant chamber 103 may be a structure having a different geometry. For example, the resonant chamber 103 may include one or more internal walls (e.g., the internal surface 114) to form a cube or square chamber, a rectangular chamber, an elliptical chamber, a spherical chamber, or another chamber having a resonant cavity 105. The specific geometries of the resonant chamber 103, and more specifically, the geometries of the resonant cavity 105 determine a resonant frequency of the resonant chamber 105, which is discussed further herein.

As the deformable membrane 110 deforms, the resonant frequency of the resonant cavity 105 is altered. A band of wavelengths may then be provided to the resonant cavity 105 to determine a shift of the resonant frequency, and to further determine the deflection of the deformable membrane 110. A velocity of the fluid flow 120 is then determined from the amount of deflection of the deformable membrane 110. The dynamic pressure, q, of the fluid flow 120 against the deformable membrane 110 may be calculated using Bernoulli's equation,

$$q = \frac{1}{2} ρ {v}^{2} , \qquad EQ . 1$$

where ρ is the fluid density of the fluid flow 120, and ν is the fluid velocity of the fluid flow 120. For simplification, the pressure exerted on the deformable membrane 110 will be modeled as a uniform pressure across the second surface 110b of the deformable membrane 110. It should be understood that non-uniform pressure may be exerted on the deformable membrane 110, and a person of ordinary skill in the art would understand that various models may be used to determine a non-uniform pressure applied by the fluid flow 120. The deflection of a circular deformable membrane 110 having a radius R, and uniform pressure applied by the fluid flow 120, may be calculated as a function of radial position, r, using Timoshenko's model

$$w ( r ) = \frac{P {R}^{4}}{64 D} ( 1 - \frac{{r}^{2}}{{R}^{2}} ) = {w}_{0} ( 1 - \frac{{r}^{2}}{{R}^{2}} ) , \qquad EQ . 2$$

where D is material flexural rigidity given as

$$D = \frac{{Ed}^{3}}{12 ( 1 - {v}^{2} )} , \qquad EQ . 3$$

with d being the thickness of the deformable membrane 110, and E and ν being Young's modulus and Poisson ratio, respectively, of the material of the deformable membrane 110.
Maximum deflecting of the deformable membrane 110 occurs at the center of the circular deformable membrane 110. The maximum deflection can be expressed as

$$w ( 0 ) = {w}_{0} = ρ {v}^{2} \frac{3 ( 1 - {v}^{2} )}{32 E} \frac{{R}^{4}}{{d}^{3}} , \qquad EQ . 4$$

with the average overall plate deflection given by

$${w}_{a v g} = \frac{1}{π {R}^{2}} {\int }_{0}^{2 π} {\int }_{0}^{R} w ( r ) r drd ϕ = \frac{{w}_{0}}{3} . \qquad EO . 5$$

The resonant frequencies of transverse electrical modes TEₙₘᵢ of the cylindrical resonant cavity 105 are calculated as

$${f}_{n m l}^{T E} = \frac{c}{2 π \sqrt{{μ}_{r} {ε}_{r}}} \sqrt{{( \frac{{X}_{n m}^{′}}{R} )}^{2} + {( \frac{l π}{L} )}^{2}} , \qquad EQ . 6$$

where μᵣ and εᵣ are the permeability and permittivity, respectively, of the substance or material inside of the resonant cavity 105 (e.g., air, or another fluid), and X′ₙₘ represents the n^{th} root of an mth order Bessel function. Further, R is the radius of the cylinder, and L is the height of the cylinder along the axis of the cylinder. EQ. 6 is used for calculating the resonant frequencies of a cylinder. A person of ordinary skill in the art would understand that other equations, or derivations, are required for determining resonant frequencies for other geometric structures. While described in terms of the transverse electric modes, the transverse magnetic TM modes may be used in the analysis of the resonant frequencies with the appropriate substitution of Xₙₘ for X′ₙₘ, with Xₙₘ being the n^{th} root of an m^{th} order Bessel function. For an air-filled resonant cavity 105, μᵣ and εᵣ are each equal to one. In examples, the cavity 105 may be filled with a fluid other than air. For example, the cavity 105 may be filled with an inert gas which may be used to provide a force against membrane deflection due to hydrostatic pressure. Use of an inert gas or other gas may be beneficial in measuring fluid flow that is deep in a pressure vessel of a nuclear reactor.

The quality factor Q of a cavity is a parameter that represents how damped the cavity is, or in other words, how lossy the cavity is. Large quality factor values indicate low loss in a resonator. The quality factor is defined as

$$Q = \frac{{f}_{0}}{Δ {f}_{F W H M}} , \qquad EQ . 7$$

where f₀ is the resonance frequency of the resonant cavity 105, and Δf_{FwHM} is the full width at half maximum of the spectral linewidth of the resonant cavity 105. Typically, the quality factor of a gas filled cavity is predominantly dependent on resistive losses of side walls such as the internal surface 114. For the examples described herein, the quality factor is dependent on both the transmission of radiation into and out of the resonant cavity 105, as well as on the electrical conductivity of both the internal surface 114, and of the material of the resonant chamber 103. The quality factor may be altered by coating the internal surface 114 with a material to change the electrical conductivity of the internal surface. For example, the internal surface may be coated with gold, silver, copper, or another electrically conductive metal. A maximum quality factor for low-order spatial modes in a cylinder, such as the TE₀₁ mode, is achieved when the height of the cylinder is equal to twice the radius of the cylinder, i.e., L=2R. As described herein, both the resonant chamber 103 and cavity 105 may be right circular cylinders with a height to radius relationship of L=2R. It is envisioned that other geometries may be used for the resonant chamber 103 and resonant cavity 105. Depending on the electrical conductivity of the material of the resonant cavity 105 and the internal wall 114, quality factors of 20,000 or greater may be achieved. Substituting L=2R, and μᵣ=εᵣ=1 for an air filled cavity 105, EQ. 6 results in a single parameter for the resonant frequency for TE spatial modes as

$${f}_{n m l}^{T E} = \frac{c}{2 π L} \sqrt{{( {X}_{n m}^{′} )}^{2} + {( l π )}^{2}} = \frac{c}{2 L} {g}^{T E} ( n , m , l ) , \qquad EQ . 8$$

where g^{TE} is a non-dimensional function of the mode number integers n,m,l, with g^{TE} being indicative of the spatial modes of the cavity 105.

Due to the dependence of the resonant frequency on the height of the cylinder, small changes (e.g., on the order of millimeters, micrometers, or even less) in the height of the resonant cavity 105 cause shifts in the resonant frequency of the resonant chamber 105. Therefore, displacement of the deformable membrane 110 causes shifts in the resonant frequency of the cavity 105. For a change in height of ΔL of the cylinder, the frequency shift of the resonant frequency is given, to a first order of ΔL, as

$$Δ f = \frac{df}{d L} Δ L = - \frac{c}{2 {L}^{2}} Δ L g ( n , m , l ) \qquad EQ . 9$$

Taking the change in height of the cylinder as the average displacement of the deformable membrane 114 from EQ. 5 results in

$$Δ L = - {w}_{a v g} = - \frac{{w}_{0}}{3} . \qquad EQ . 10$$

Further, substituting the results of EQ. 10 and L=2R into EQ. 9 results in a frequency shift of

$$Δ f = g ( n , m , l ) \frac{1 - {v}^{2}}{256 E} \frac{c {R}^{2}}{{d}^{3}} ρ {v}^{2} . \qquad EQ . 11$$

The results of EQ. 11 show that flow velocity measurement sensitivity increases quadratically with the radius of the cylinder R, and has an inverse cubic relationship with the thickness of the deformable membrane 110. The frequency shift may span from 0.5 to 1 MHz, from 1 to 5 MHz, from 1 to 10 MHz, from 0.5 to 20 MHz, less than 20 MHz, less than 10 MHz, or less than 5 MHz. Additionally, the sensitivity of the measured frequency shift may be on the scale of kHz, tens of kHz, or hundreds of kHz. Therefore, depending on the quality factor of the cavity 105, the sensitivity of the flow velocity measurement may be 1 gpm, 0.1 gpm, 0.01 gpm, between 0.001 and 0.1 gpm, between 0.1 and 1 gpm, between 0.1 and 5 gpm, or between 1 and 10 gpm. Additionally, the thickness of the deformable membrane 110 may determine a maximum amount of pressure that may be applied, and therefore, a maximum fluid velocity that may be measured by a device. As a result, there is a trade-off; a thicker deformable membrane 110 results in the ability to measure greater fluid velocities, while a thinner deformable membrane allows for greater fluid velocity sensitivity measurements. As described by the equations above, the fundamental sensitivity and resolution measurement range of the fluid flow measurement device disclosed herein is dependent on various factors such as the thickness of the deformable membrane 110, the radius of the deformable membrane 110, temperature of the fluid, density of the fluid, and quality factor of the cavity 105, among other potential factors.

For embodiments described herein, stainless steel will be used as an example as the material used for the resonant chamber 103 including the inner surface 114 and bottom wall 117, and for the deformable membrane 110. The material properties of the deformable membrane 110 and other parts of the resonant chamber 103 are required to determine the various parameters (e.g., maximum fluid flow velocity, corrosive and radiative conditions, maximum temperature of the fluid, etc.) under which the resonant chamber 103 may be used for performing fluid flow measurements. Young's modulus, E, provides a measure of the ability of a material to undergo changes in length, without deformation, when under a lengthwise tension of compression. The shear modulus, G, provides a measure of the rigidity of a material and is defined by a limit of the ratio of shear stress over shear strain that can be applied to a material before deformation. The Poisson ratio, v, of a material ids a measure of the deformation of a material in a direction that is perpendicular to an applied force on the material. Each of these material parameters is a function of temperature of the material. For stainless steel 316, these material parameters are defined as E=2.137×10⁵−102.74T, G=8.964×10⁴−53.78T, and v=E/2G−1, where E and G and in MPa, and Tis given in ° C. Further, for stainless steel 316, these temperature dependent correlations are valid for temperatures between 0 and 800° C.

Material properties of the fluid being measured must also be taken into account for determining the fluid velocity of the fluid. For example, thicker or more viscous materials may cause the deformable membrane 110 to deflect greater amounts than less viscous materials at a same velocity. Liquid sodium will be used for examples herein for discussions of the disclosed fluid flow measurement device. The density of liquid sodium, ρ, in kg/m³, is given by the temperature dependent relationship

$$ρ = {ρ}_{c} + f ( 1 - \frac{T}{{T}_{c}} ) + {g ( 1 - \frac{T}{{T}_{c}} )}^{h} , \qquad EQ . 12$$

$$for 371 K < T < 2503.7 K$$

where T is temperature in units of Kelvin, ρ_{c} is a material dependent density constant which is 219 for liquid sodium, constant f is 275.32, constant g is 511.58, his equal to 0.5, and T_{c} is 2503.7K. All of the given constants are fitting coefficients for determining the specific fit used. As a person of ordinary skill in the art would recognize, other fits and approximations for material densities may be applied. Using the analysis and equations provided above, the resonant frequency shift of a cylindrical cavity was calculated using software, such as a COMSOL RF software module.

While described herein as measuring fluid flow velocity, the resonant chamber 103 and associated methods of measuring resonant frequency shift may be used to measure other factors and parameters. By providing a band of frequencies to the resonant cavity (e.g., via a frequency sweep) different spatial modes and resonant harmonics, and frequency shifts of resonant spatial modes and harmonics, can be measured simultaneously in a single frequency sweep. Therefore, a single resonant chamber, or a plurality of resonant chambers, may provide measurements of various parameters simultaneously. For example, in addition to fluid flow velocity the resonant chamber 103 may be used to measure fluid temperature, hydrostatic pressure, the fill level of fluid in a vessel, and/or fluid density. Also, it should be understood that the fluid may be a gas or liquid and that the measured parameters may correspondingly be for gas or liquid fluids.

In examples, the resonant chamber 103 may be placed in a fluid having no fluid flow, or placed in a fluid with the deformable membrane 110 being disposed away from a fluid flow. FIG. 1B is a cut-away perspective view of the resonant chamber 103 disposed in a fluid flow 121 that impinges on the bottom wall 117. The fluid flow 121 in FIG. 1B does not provide a direct force of pressure on the deformable membrane 110. Still, the deformable membrane 110 will deform due to forces applied by other physical factors such as hydrostatic pressure, pressurization of the fluid, and/or temperature of the fluid. Therefore, the configuration of FIG. 1B may be useful to performing measurements of other fluid characteristics, without the effects of forces due to fluid flow velocity on the deformable membrane 110. While illustrated as impinging on the bottom wall 117, the resonant chamber 103 may be disposed in a fluid with the fluid flow perpendicular to a region of the outer surface 112 of the resonant chamber 103. In such a configuration, the fluid flow impinges on the outer surface 112 in a direction in the plane of the deformable membrane 110 allowing for reduced pressure applied on the deformable membrane 110 due to the fluid flow velocity. Further, in the presence of no fluid flow, the resonant chamber 103 may be disposed in a tank of pressurized fluid, and the deflection of the deformable membrane 110 may be measured to determine and monitor the pressurization of fluid in the tank or chamber. In implementations, multiple resonant cavity transducers with different orientations may be disposed in a fluid, at different positions along the fluid flow, to measure flow velocities, pressures, or a temperature profile along the fluid.

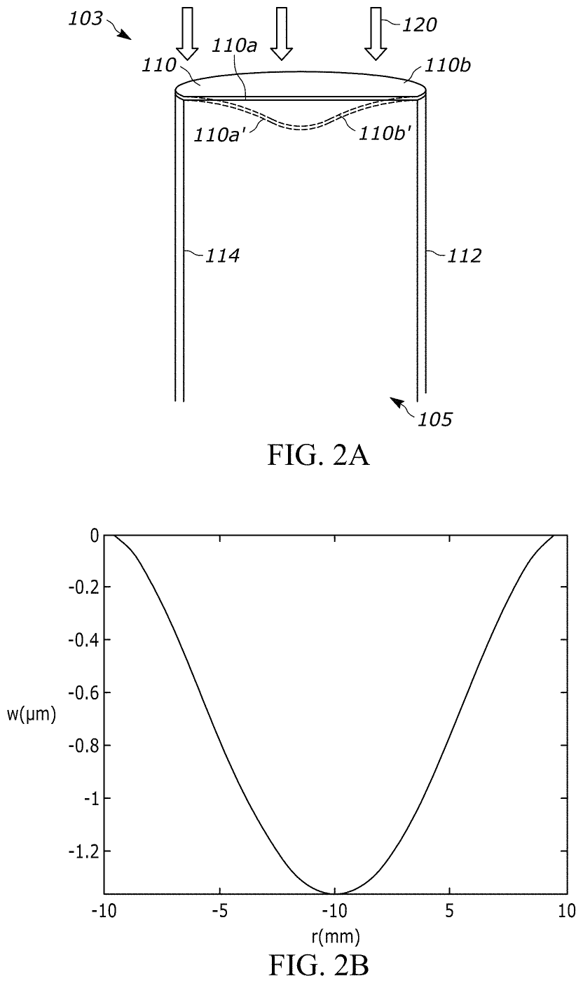

FIG. 2A illustrates a cut-away side view of the resonant chamber 103 illustrating deflection of the deformable membrane 110 having a force applied by fluid flow against the deformable membrane 110. Without a fluid flow, or other pressure applied to the deformable membrane 110, the first and second surfaces 110a and 110b are generally flat and do not deform due to any applied force. When the fluid flow 120, or another force or pressure, is applied to the deformable membrane 110, each of the first and second surfaces 110a and 110b deform into deflected first and second surfaces 110a′ and 110b′ which changes the volume of the cavity 105 of the resonant chamber 103. The change in volume of the cavity 105 further changes the resonant frequency of the cavity 105, which may be used to determine the amount of force or fluid flow velocity of against the deformable membrane 110. FIG. 2B is a plot of deflection, w, in microns versus radial position across the deformable membrane 110 of the plot of FIG. 2A. The plot of FIG. 2B shows a maximum displacement at the center of the deformable membrane 110 with a quadratic trend at the center, that decreases to zero deflection at the edges of the deformable membrane 110, as given by EQ. 2. In implementation, a certain amount of displacement may be required to perform a fluid flow measurement. For example, a measurement may require a displace of 0.5 μm, 1 μm, 1.5 μm, 2 μm, or on the order of microns may be required. A range of displacements may be required for performing fluid flow measurements, such as displacements from 0.25 to 1 μm, 0.5 to 2 μm, from 1 to 2 μm, from 0.5 to 5 μm, from 1 to 5 μm, less than 5 μm, or less than 10 μm. Other wavelengths of radiation may require ranges of displacement that are greater, or less than, the specified ranges depending on the specific wavelengths of radiation, and quality factor of the resonant cavity 105.

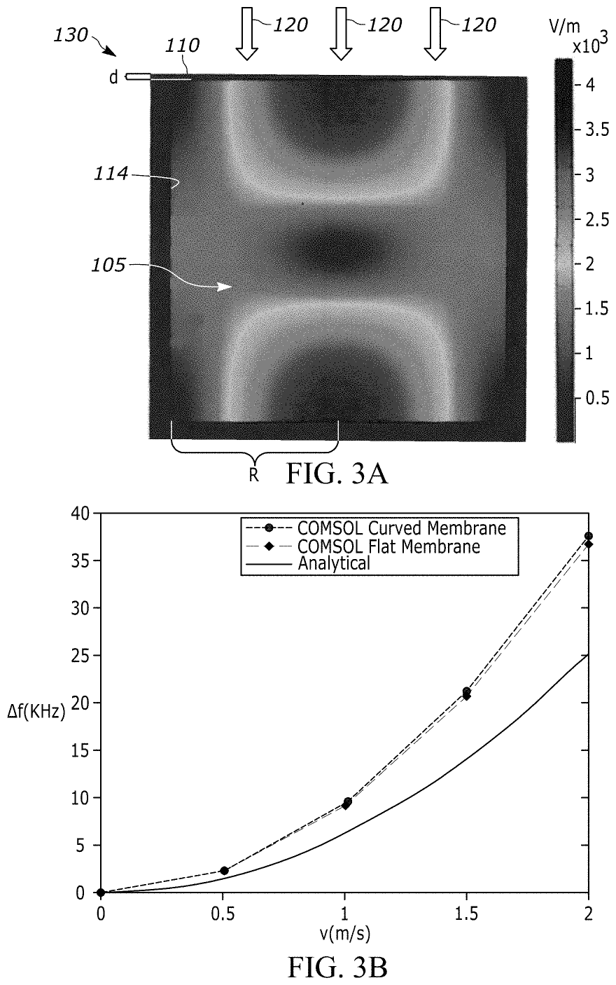

Multiple simulations of determining fluid flow velocity were performed for a variety of electromagnetic spatial modes for resonant cavities having various geometries. FIGS. 3A and 3B present simulation results for a cylindrical resonant cavity having a radius of R=0.35 in and a deformable membrane thickness of d=11.1 mil. As used throughout this application, 1 mil is to be understood as 0.001 inches. FIG. 3A is a plot of a TM₀₁₁ electromagnetic spatial mode inside of the cylindrical cavity 105. The resonant electric field shown in FIG. 3A occurred at 15.4 GHz. The deformable membrane 110 is simulated as the top boundary in FIG. 3A, with water being the simulated fluid flowing against the deformable membrane 110. As described, the resonant frequency of the spatial mode supported by the resonant cavity 105 shifts as the deformable membrane 110 deflects under pressure due to the fluid flow 120. FIG. 3B is a plot of the frequency shift of the resonant cavity 105 and a corresponding velocity of a 500° C. fluid flow 120 provided against the deformable membrane 110 of the cavity mode in FIG. 3A. FIG. 3B shows strong agreement between COMSOL simulations performed with a curved membrane model, flat membrane model, and the analytical method provided by the equations and analysis above. The curved membrane model allowed for bending of the deformable membrane, the flat membrane model only allowed for the entire membrane to shift position into the cavity 105 without bending of the membrane 110, and the analytical model used the provided equations above.

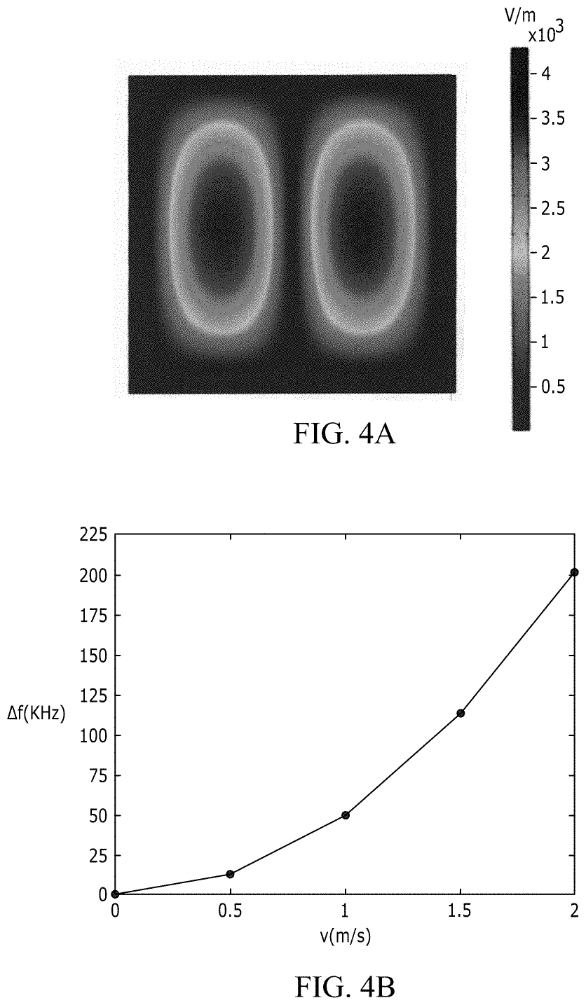

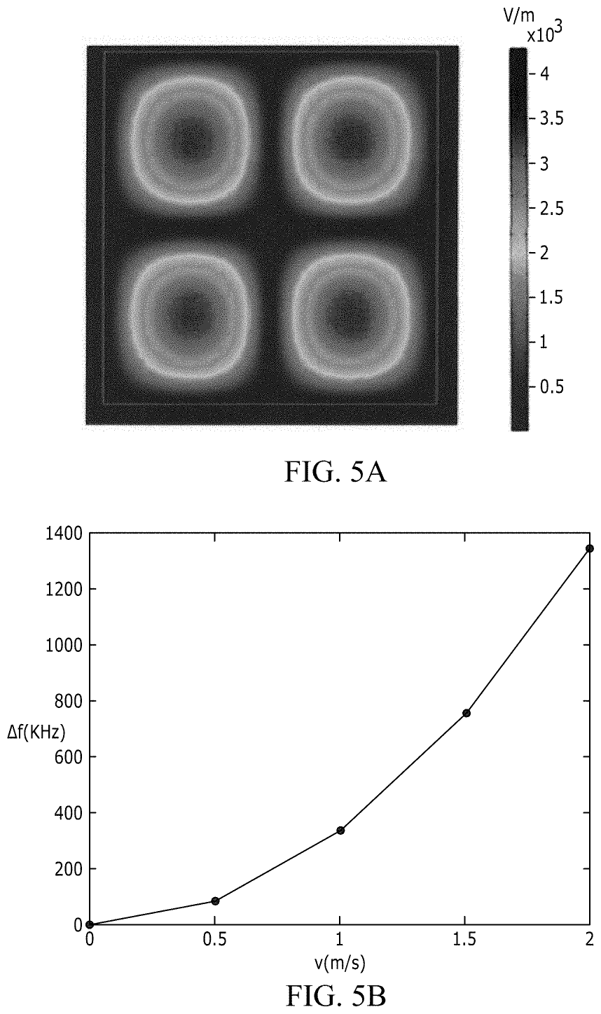

FIGS. 4A, 4B, 5A, and 5B provide results of simulations of fluid flow measurements using a stainless steel cylindrical resonant cavity with a radius of R=0.35 in, a deformable membrane thickness of d=10 mil, and a cylinder height of L=2R=0.7 in. FIG. 4A is a modal map of a TE₀₁₁ spatial mode in the resonant cavity. The resonant frequency of the cavity without deformation of the deformable membrane was found to be 22 GHz, with a resonator quality factor of Q=17,900. FIG. 4B is a plot of resonance frequency shifts of the TE₀₁₁ mode for a range of fluid flow velocities. The frequency shifts were simulated for a 500° C. flow of liquid sodium with flow velocities from 0.5 m/s to 2 m/s. The deformable membrane deflection was determined using EQ. 2. Comparing the plots of FIGS. 3B and 4B shows that the frequency shift of the TE₀₁₁ mode in FIG. 4B is much greater than the frequency shift of the TM₀₁₁ mode for same fluid velocities.

FIG. 5A is a modal map of a TE₀₁₂ spatial mode in the resonant cavity. The resonant frequency of the TE₀₁₂ mode occurs at 26.5 GHz with a quality factor of Q=19,500. FIG. 5B is a plot of the resonant frequency shift with the deformable membrane under pressure from a 500° C. flow of liquid sodium with flow velocities from 0.5 m/s to 2 m/s. The frequency shifts of the TE₀₁₂ mode are higher than the modes of FIGS. 3A and 4A due to the higher quality value and the broader spatial distribution profile of the higher order mode.

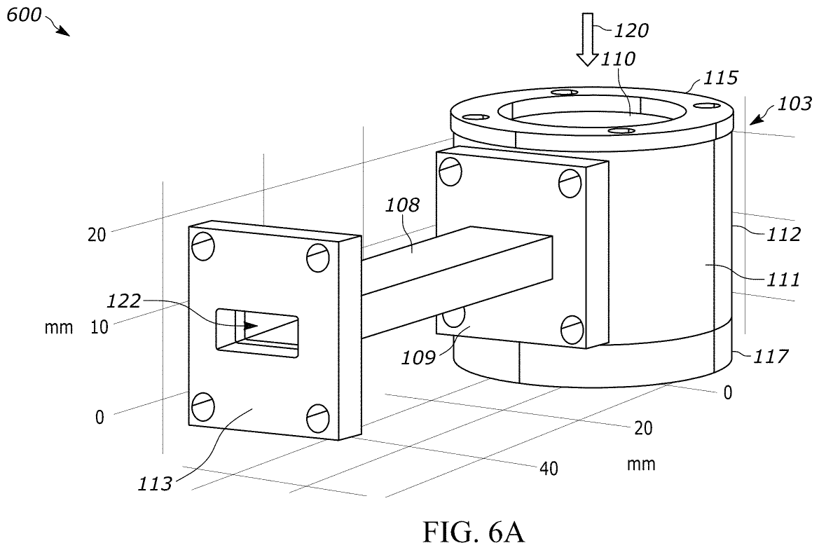

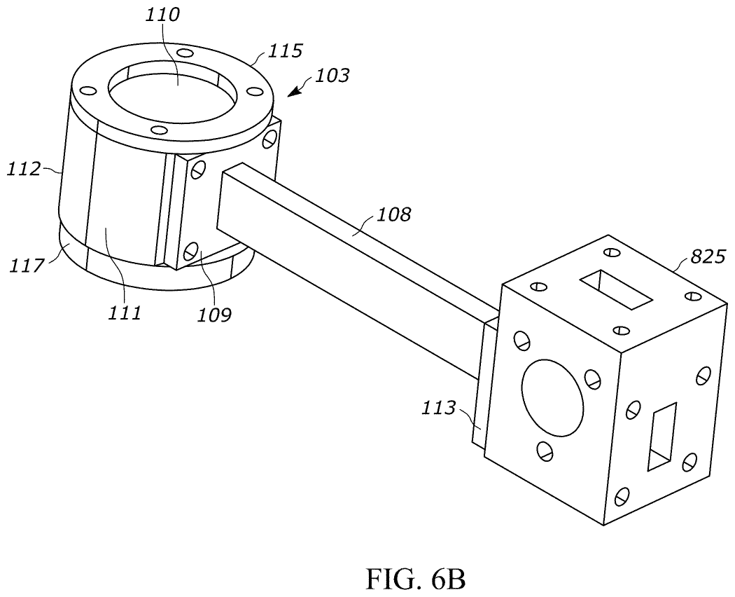

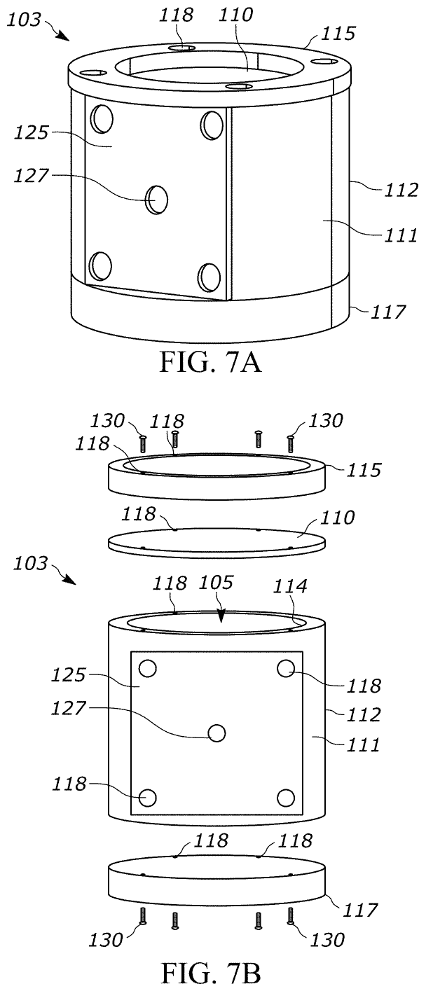

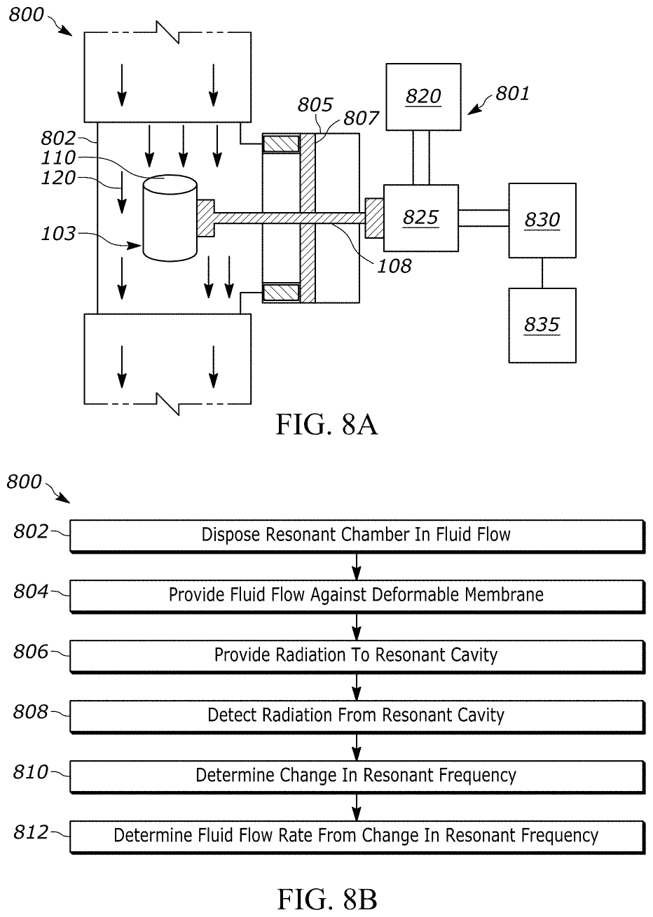

FIGS. 6A and 6B are perspective views of a flow sensor 600 for performing high-temperature fluid flow velocity measurements. The flow sensor 600 includes a resonant chamber 103, and a waveguide 108 physically coupled to the resonant chamber 103. The waveguide 108 guides radiation from a radiation source (not illustrated in FIG. 6) to the resonant chamber 103 through a hollow core 122. The waveguide 108 injects radiation into the resonant chamber 103, and the waveguide 108 further guides radiation away from the resonant chamber 103. The radiation is injected into the resonant chamber 103, and radiates out of the chamber 103, through a subwavelength hole discussed further in reference to FIGS. 7A and 7B. The waveguide 108 may be a microwave waveguide. The waveguide 108 may be asymmetric to guide horizontally polarized, or vertical polarized radiation, as illustrated by the rectangular waveguide at horizontal and vertical orientations in FIGS. 6A and 6B respectively. As such, the resonant cavity 103 may have higher quality values for certain electromagnetic polarizations, and therefore, the waveguide 108 may be configured accordingly. FIG. 6B further includes a microwave circulator 825 electrically coupled to the waveguide 108 to provide radiation to, and receive radiation from, the waveguide 108, as further described in reference to FIG. 8A.

The waveguide 108 may guide radiation having a frequency in the range of 1 GHz to 300 GHz. In examples, the waveguide 108 may be a waveguide that guides another band of wavelengths having a resonant frequency of the resonant chamber 103. In examples, the waveguide 108 may be a hollow waveguide as illustrated in FIG. 1 for guiding microwave radiation. In other examples, the waveguide may be a transmission line, a rigid rectangular waveguide, a circular waveguide, or a high temperature coaxial cable. The waveguide 108 provides the radiation into the resonant chamber 103 through a radiation coupler, discussed further in reference to FIGS. 7A and 7B. The waveguide 108 has a first mount plate 113 that operatively couples the waveguide 108 to one or more radiation sources, circulators, and radiation detectors. A second mounting plate 109 physically couples the waveguide 108 to the resonant chamber 103. The first and second mounting plates 113 and 109, respectively, may be physically coupled to other elements by screws, bolts, welding, an adhesive, or by another means.

The flow sensor includes a resonant chamber 103 with a bottom wall 117, a deformable membrane 110, and a central cylinder 111 with an external surface 112. The deformable membrane 110 may be physically coupled to the central cylinder 111 by welding, adhesive, clamps or by another means. In the illustrated embodiment, a fastener ring 115 physically couples the deformable membrane 110 to the central cylinder 111 to form a resonant cavity inside of the central cylinder 111. In operation, the resonant chamber 103 is placed in a fluid flow 120 with the fluid providing a pressure to the deformable membrane 110.

FIGS. 7A and 7B are perspective and exploded views, respectively, of the resonant chamber 103 of FIG. 6. The resonant chamber 103 further includes screw holes 118 and screws 130 that mount the bottom wall 117 to the central cylinder 111, and screws 130 that physically couple the fastener ring 115 to the central cylinder 112 to clamp the deformable membrane 110 between the fastener ring 115 and the central cylinder 111. The central cylinder 111 has a radiation coupling surface 125 that is a flat surface with screw holes 118 for physically mounting the waveguide 108. The radiation coupling surface 125 includes a transmission port 127 that transmits radiation from the waveguide 108 into the resonant cavity 105 of the resonant chamber 103. The transmission port 127 may have a diameter that is smaller than a wavelength of the radiation provided to the transmission port 127. A subwavelength sized transmission port 127 increases the quality factor of the resonant cavity 105 because it reduces the amount of radiation transmitted out of the cavity (i.e., reduces lossiness of the cavity 105). Smaller transmission ports 127 also reduce the amount of radiation injected into the cavity 105. Therefore, there is a trade-off between coupling efficiency of radiative energy into the cavity 105, and degradation of the quality factor of the cavity 105 which may be an important consideration in selecting a size of the transmission port 127. The trade-off between quality factor and coupling efficiency is further dependent on the band of wavelengths of the provided radiation. The transmission port 127 may have a diameter greater than a wavelength of the provided radiation, which would reduce the quality factor of the radiation cavity. A lower quality factor cavity may require longer measurements times or more radiation for performing a fluid flow velocity measurement.

In embodiments, the radiation coupling surface 125 may include two transmission ports 127, with each transmission port 127 coupled to a respective waveguide. As such, one waveguide may provide radiation to a first transmission port for injecting radiation into the cavity 105, while the second waveguide receives radiation that escapes from the cavity through the second transmission port. The first waveguide may further be electrically coupled to a radiation source, while the second waveguide is electrically coupled to a radiation detector. The described embodiment with two transmission ports 127 and two waveguides 108 requires more components than the illustrated single waveguide flow measurement system described herein. Further, the two transmission port 127 example requires more components be disposed in a fluid flow which may provide more disruption and obstruction of the fluid flow.

In examples, The chamber 103 may have more than one radiation coupling surface 125 on the external surface 112 of the chamber 103. Each of the radiation coupling surfaces 125 may have a respective transmission port 127 with a waveguide 108 coupled to each surface 125 to provide radiation to, or receive radiation from, a corresponding transmission port 127. Each transmission port 127 may be a hole with a diameter dependent on the wavelength of provided radiation, and the amount of radiation to be injected into, or transmitted out of, the cavity 105 of the chamber 103. In other examples, multiple chambers 103 may be disposed adjacent to each other and may share a single external surface 112 with each chamber 103 having a respective radiation coupling surface 125 each with a transmission port 127. The waveguide 108 may provide different bands of wavelengths of radiation to each chamber 103 through multiplexing/demultiplexing (e.g., using Bragg gratings, microwave filters, etc).

While described in further examples as having a single resonant chamber 103, other geometries and embodiments of a fluid measurement device are envisioned. For example, a dual-chamber transducer with each chamber sharing a common bottom wall 117 may be disposed in a pipe or reactor pressure vessel to simultaneously measure fluid flow, and another parameter such as hydrostatic pressure. Each chamber of the dual-chamber transducer has a deformable membrane 110 facing an opposite direction in the pipe or pressure vessel. One of the deformable membranes 110 is disposed to receive a fluid flow against the second surface 110b of the deformable membrane 110, while the opposite deformable membrane 110 does not receive any force from fluid flow. Hydrostatic pressure provides a force against the second surface 110b of the deformable membrane 110 that is faced away from the fluid flow. Therefore, the deflections of the deformable membranes 110 of the dual-chamber transducer 110 are different due to the different forces applied to each membrane. As such, shifts of respective resonant frequencies of the two chambers 105 may be independently measured to determine two different parameters simultaneously using a single transducer device. For example, the dual-chamber transducer may simultaneously measure fluid flow velocity, fluid temperature, hydrostatic pressure, amount of fluid fill of a vessel, and/or fluid density.

FIG. 8A is a schematic diagram of a fluid flow measurement system 801 performing fluid flow measurements in an operational environment 800. FIG. 8B is a flow diagram of a method 850 for performing a fluid flow measurement as may be performed by the system 801 of FIG. 8A. For clarity, the method 800 of FIG. 8B will be discussed with reference to elements of FIG. 8A. A resonant chamber 103 of the fluid flow measurement device 801 is disposed in a fluid flow 120 of a pipe 802 or flow channel (block 852). The fluid flow 120 provides pressure to a deformable membrane 110 of the resonant cavity 103 (block 854). A waveguide 108 is physically coupled to the resonant chamber 103 to provide radiation to the resonant chamber 103. The waveguide 108 is inserted into the pipe 802 through an input port 805 of the pipe 802. A mounting plate 807 is physically coupled to both the waveguide 108 and the input port 805 to mount the resonant chamber 103 in the fluid flow 120. The mounting plate 807 further provides a seal with the input port 805 to prevent fluid from the fluid flow 120 from leaking out of the input port 805. The mounting plate 807 may be a cylindrical disk that surrounds the waveguide 108. For example, the mounting plate 807 may be a flange that surrounds and extends from the waveguide 108, such as the flange of a WR-42 waveguide bulkhead. The mounting plate 807 may be welded or fused to the waveguide 108, and the mounting plate 807 may be coupled to the input port 805 by screws, bolts, clamps, or by another means that may allow for the mounting plate 807 to be inserted and removed from the input port 805.

The fluid flow measurement system 801 further includes a radiation source 820, a circulator 825, a radiation detector 830, and a processor 835. The radiation source 820 is electrically coupled to the resonant chamber 103, and the radiation source 820 provides radiation to a resonant cavity of the resonant chamber 103 (block 806). In embodiments, to provide radiation to the resonant chamber 103, the radiation source 820 is electrically coupled to the circulator 825, and configured to provide radiation to the circulator 825. The radiation source 820 may be a microwave radiation source 820 that provides microwave radiation to the circulator 825. The circulator 825 is configured to receive the radiation from the radiation source 820, and provide the received radiation to the waveguide 108. The waveguide 108 guides the radiation to the resonant chamber 103 and injects radiation into the resonant chamber 103 via a transmission port, such as the transmission port 127 of FIGS. 7A and 7B. At least a portion of the radiation is emitted from the cavity 105 through the subwavelength sized transmission port 127 back into the waveguide 108. The waveguide 108 guides the radiation 108 emitted from the resonant chamber 103 back to the circulator 825. The circulator 825 receives the emitted radiation, and further provides the emitted radiation to the radiation detector 830. The radiation detector 830 detects the radiation and generates a signal indicative of the radiation emitted from the resonant chamber 103 (block 808). The radiation detector 830 may be a microwave radiation detector that generates a signal indicative of a radiative power (e.g., in dB) of the detected radiation. Each of the radiation source 820, circulator 825, radiation detector 830, and waveguide 108 may be electrically coupled via coaxial cables, a strip line, or another transmission line capable of transporting microwaves.

The radiation detector 830 provides the signal to the processor 835. The processor 835 executes machine readable instructions to process the signal and determine a resonant frequency, and a change in the resonant frequency, of the cavity of the resonant chamber 103 (block 810). The radiation source 820 may provide a band of wavelengths of radiation at one time to the resonant chamber 103, or the radiation source 820 may perform a frequency sweep providing a band of wavelengths of radiation over a period of time. The detector 830 may determine a power spectrum of the band of wavelengths, and determine, from the power spectrum, the resonant frequency. The resonant frequency may be measured in real time to perform continuous fluid flow velocities of the fluid flow 120. In examples, the processor 835 may determine the resonant frequency as a local minimum, or local maximum, of the power spectrum. The processor 835 may provide a plot of the power spectrum to a user via a display, for a user to manually determine the resonant frequency via visual inspection. The processor 835 further determines a fluid flow rate from the determined change in resonant frequency (block 812).

A fluid flow measurement device was fabricated according to the system 800 illustrated in FIG. 8A. The cylindrical resonant chamber 103 was formed from brass having cavity dimensions resulting in a cavity resonant frequency in the microwave K-band. The radiation source 820 provided K-band microwave radiation to the waveguide 108, and the microwave radiation was coupled into the resonant cavity through a subwavelength-size aperture. A piping Tee including the fluid line 820 and input port 805 was used with a bulkhead WR-42 microwave waveguide installed in a leak-proof assembly. Power spectrum characterization of cavity spectral response was performed with a portable PXIe chassis microwave VNA and a graphical user interface (GUI). While the VNA was used for proof-of-concept demonstrations, a monolithic microwave integrated circuit (MMIC) may be used for the same purposes.

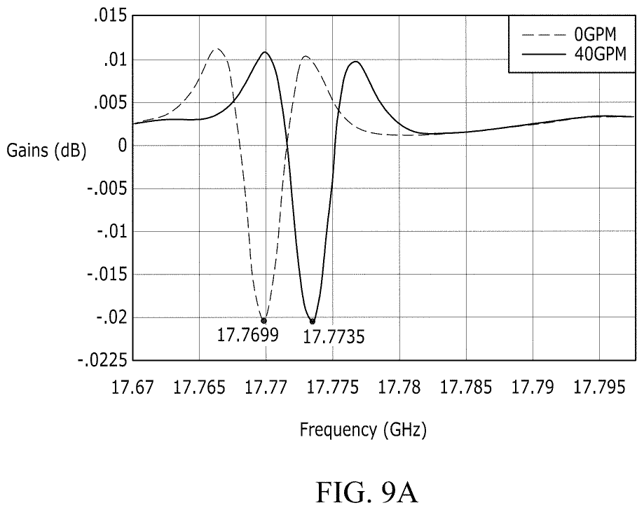

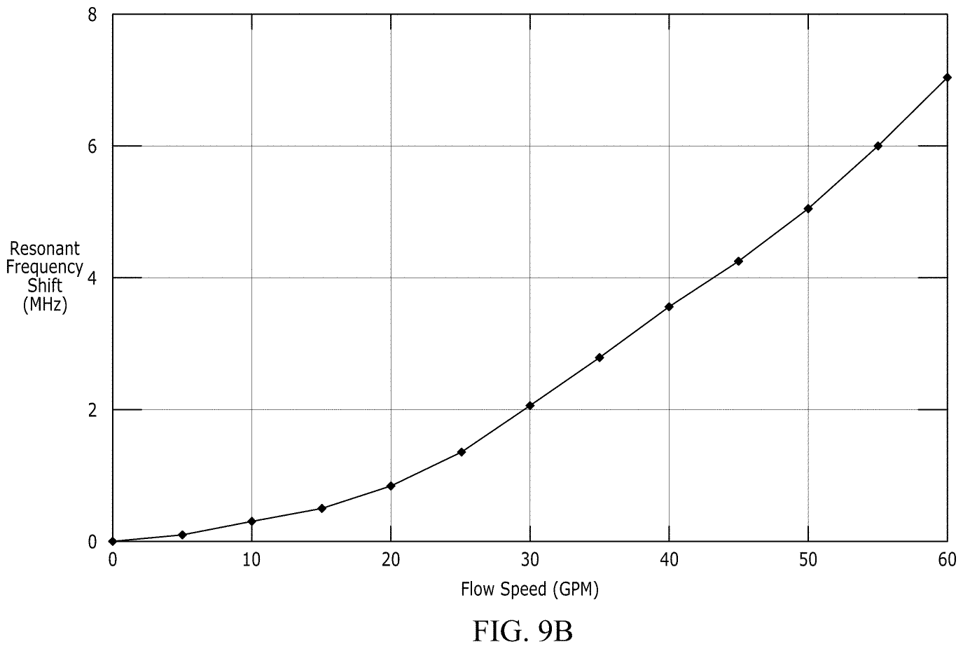

FIG. 9A and is a plot of power spectra of reflected radiation from the resonant chamber 103 illustrating a resonant frequency shift due to fluid flow against the deformable membrane 110. The data presented in FIG. 9A was taken by measuring the flow velocity of water at room temperature. Without fluid flow, the resonant frequency of the cavity is observed by a power minimum at 17.7699 GHz. The resonant frequency of the cavity shifted to 17.7735 GHz when a 40 gpm fluid flow was provided against the membrane. The resultant shift was 3.6 MHz.

FIG. 9B is a plot of measured frequency shift and determined flow speed. The curve of FIG. 9B was determined by measuring the resonant frequency shift, and therefore the deflection of a deformable membrane due to fluid flow as described herein. Simultaneously, the same fluid flow as measured using a commercial off-the-shelf fluid flow meter. The frequency shifts and corresponding flow speed measurements provide a calibration curve for the described fluid flow measurement transducer. The disclosed transducers may have broader ranges of fluid flow measurement, and/or greater sensitivity allowing for greater overall resolution measurements than other systems. In the example of the data presented in FIG. 9B, the commercial flow measurement device may have a resolution granularity of 6 GPM. Once the calibration has been performed for a resonant cavity based transducer described herein, the overall resolution of the fluid measurements may be increased by interpolating between the data points of FIG. 9C, providing improved measurements and functionalities over other fluid measurement devices. The data presented in FIG. 9B shows the frequency shift of the resonant chamber 103 to be monotonically increasing with increasing pressure from the fluid flow.

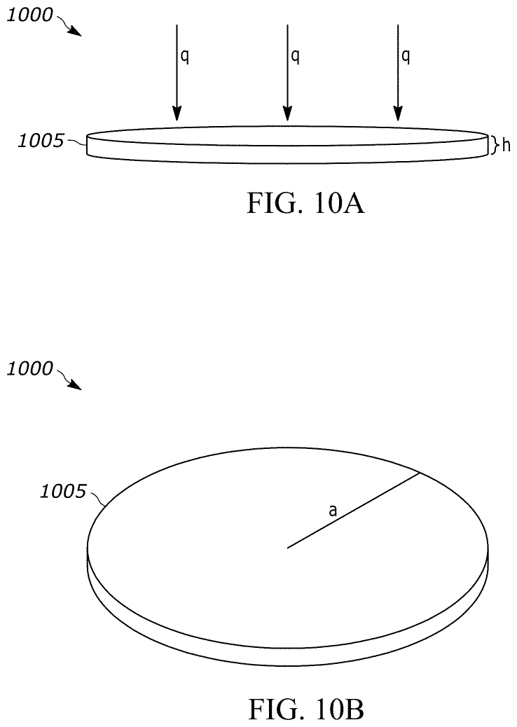

The mechanical resilience of the deformable membrane determines a lifetime of a high-temperature fluid flow measurement device as described herein. Therefore, a further study of mechanical resilience of the deformable membrane was conducted to determine maximum stress and strain that a deformable membrane may undergo during fluid flow velocity measurements. FIGS. 10A and 10B are perspective views of a deformable membrane 1000 having a radius a, and a thickness h. A pressure q is provided to the deformable membrane. The maximum stress at a radial boundary 1005 of the deformable membrane 1000 is represented by

$${σ}_{max} = \frac{3}{4} q \frac{{a}^{2}}{{h}^{2}} . \qquad EQ . 13$$

Dynamic fluid pressure is related to fluid velocity and fluid density through Bernoulli's equation

$$q = \frac{1}{2} ρ {v}^{2}$$

where ρ and ν are fluid density and fluid velocity, respectively. The maximum allowable stress of at the radial boundary 1005 is further dependent on a temperature of the fluid through temperature-dependent fluid density. For example, the density of FLiBe molten salt changes by less than 1% for a 100K temperature change. Therefore, changes of fluid density by less than a factor of 2 may be neglected in determining maximum stress values.

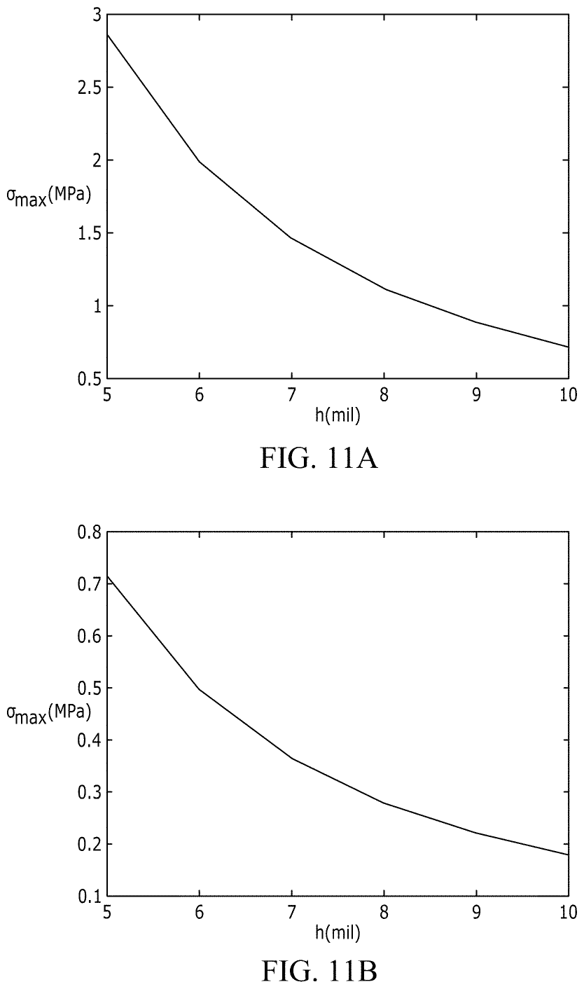

FIGS. 11A and 11B are plots of maximum stress at the radial boundary 1005 of the deformable membrane 1000 having a radius of 11.1 mm for membrane thicknesses from 5 to 10 mil. FIG. 11A shows the maximum stress over varied thicknesses with a provided pressure of 1 m/s. The fluid used in the models of FIGS. 11A and 11B was water at room temperature. The maximum stress applied by the pressure in FIG. 11A is about 1.9 MPa, just under 3 MPa. FIG. 11B shows the maximum stress at the radial boundary 1005 for thicknesses of 5 to 10 mil under a pressure of 0.7 MPa. The maximum stress in FIG. 11B is shown to be less than 0.8 mil. The maximum stress values illustrated in FIGS. 11A and 11B are three orders of magnitude less than the yield stress, and ultimate tensile strength of stainless steel. Therefore, stainless steel is one viable option of a material for fabricating a resonant chamber, and specifically, deformable membrane, for high-temperature fluid flow measurement devices as described herein.

The following list of aspects reflects a variety of the embodiments explicitly contemplated by the present disclosure. Those of ordinary skill in the art will readily appreciate that the aspects below are neither limiting of the embodiments disclosed herein, nor exhaustive of all of the embodiments conceivable from the disclosure above, but are instead meant to be exemplary in nature.

1. A flow measurement device comprising: a resonant chamber defined by an inner surface of a hollow resonant cavity; a deformable membrane having a first side forming a wall of the hollow resonant cavity, and a second side in contact with an external environment in which the resonant chamber is disposed; and a waveguide physically coupled to the resonant cavity, the waveguide configured to provide to the resonant chamber a band of wavelengths of radiation.

2. The device of aspect 1, wherein the waveguide comprises a microwave waveguide.

3. The device of aspect 1 or 2, wherein the waveguide comprises a hollow waveguide.

4. The device of any of aspects 1 to 3, wherein the resonant chamber comprises a cylindrical chamber.

5. The device of any of aspects 1 to 4, wherein the resonant cavity has a resonant frequency in the microwave range.

6. The device of any of aspects 1 to 5, further comprising a coating disposed on at least one of the one or more internal walls of the resonant chamber.

7. The device of any of aspects 1 to 6, wherein the coating comprises one or more of silver, gold or copper.

8. The device of any of aspects 1 to 7, wherein the deformable membrane comprises a circular sheet of metal having a thickness of between 1 and 20 mil.

9. The device of any of aspects 1 to 8, wherein the resonant chamber comprises a material selected from the group consisting of brass, stainless steel, and Inconel® alloy or alloys.

10. The device of any of aspects 1 to 9, wherein the deformable membrane comprises a material selected from the group consisting of brass, stainless steel, and Inconel® alloy or alloys.

11. The device of any of aspects 1 to 10, wherein the resonant chamber further comprises: one or more outside walls of the resonant chamber; a radiation coupler disposed on one of the one or more outside walls, the radiation coupler being transmissive to radiation from the waveguide into the resonant cavity.

12. The device of aspect 11, wherein the radiation coupler comprises a hole through the outside wall, the hole having a diameter smaller than a shortest wavelength of the band of wavelengths.

13. The device of either aspect 11 or 12, further comprising: a radiation source operatively coupled to the waveguide, the radiation source configured to provide radiation to the waveguide; a detector operatively coupled to the waveguide, the detector configured to receive radiation from the waveguide; and a radiation circulator operatively coupled to the radiation source, the waveguide, and the receiver, the radiation circulator configured to (i) receive radiation from the radiation source, (ii) provide radiation to the waveguide, (iii) receive radiation from the waveguide, and (iv) provide radiation to the detector.

14. The device of aspect 13, wherein the radiation source is a microwave radiation source.

15. A method for performing flow measurement of a fluid, the method comprising: disposing, in a fluid flow, a device according to aspect 1, the device disposed such that the fluid flow is orthogonal to the deformable membrane; providing fluid flow against a deformable membrane; providing, from a radiation source, radiation to the resonant cavity at a resonant frequency; detecting, by a radiation detector, radiation from the resonant cavity; determining, by a processor, a change in the resonant frequency of the resonant cavity; and determining, by the processor, a fluid flow rate from the change in the resonant frequency.

16. The method of aspect 15, wherein providing radiation to the resonant cavity comprises: providing, by the radiation source, radiation to a waveguide, the waveguide being operatively coupled to the radiation source and the resonant cavity; and providing, by the waveguide, the radiation to the resonant cavity.

17. The method of aspect 16, wherein the waveguide comprises a microwave radiation waveguide.

18. The method of any of aspects 15 to 17, wherein the resonant chamber comprises a cylindrical chamber.

19. The method of any of aspects 15 to 18, wherein the resonant frequency is in the microwave range.

20. The method of any of aspects 15 to 19, wherein the chamber includes a coating on an inner wall of the resonant chamber.

21. The method of any of aspects 15 to 20, wherein the deformable membrane comprises a circular sheet of metal having a thickness of less than 5 millimeters.

22. The method of any of aspects 15 to 21, wherein the resonant chamber comprises a material selected from the group consisting of brass, stainless steel, and Inconel® alloy or alloys.

23. The method of any of aspects 15 to 23, wherein the deformable membrane comprises a material selected from the group consisting of brass, stainless steel, and Inconel® alloy or alloys.

24. The method of any of aspects 15 to 24, wherein the radiation source is a microwave radiation source.

What is claimed is:

1. A flow measurement device comprising:
a resonant chamber defined by an inner surface of a hollow resonant cavity;
a deformable membrane having a first side forming a wall of the hollow resonant cavity, and a second side in contact with an external environment in which the resonant chamber is disposed; and
a waveguide physically coupled to the resonant chamber, the waveguide configured to provide to the resonant cavity a band of wavelengths of radiation.

2. The device of claim 1, wherein the waveguide comprises a microwave waveguide.

3. The device of claim 1, wherein the waveguide comprises a hollow waveguide.

4. The device of claim 1, wherein the resonant chamber comprises a right cylindrical cylinder.

5. The device of claim 4, wherein the right circular cylinder has a height and a radius, with the height being twice the radius.

6. The device of claim 1, wherein the resonant cavity has a resonant frequency in the microwave range.

7. The device of claim 1, further comprising a coating disposed on at least one of the one or more internal walls of the resonant chamber.

8. The device of claim 7, wherein the coating comprises one or more of silver, gold, or copper.

9. The device of claim 1, wherein the deformable membrane comprises a circular sheet of metal having a thickness of between 1 and 20 mil.

10. The device of claim 1, wherein the resonant chamber comprises a material selected from the group consisting of brass, stainless steel, and Inconel® alloy or alloys.

11. The device of claim 1, wherein the deformable membrane comprises a material selected from the group consisting of brass, stainless steel, and Inconel® alloy or alloys.

12. The device of claim 1, wherein each of a thickness and a radius of the deformable membrane are selected such that the deformable membrane has a deflection distance between 0.5 and 5 μm.

13. The device of claim 1, wherein the resonant chamber further comprises:
one or more outside walls of the resonant chamber;
a radiation coupler disposed on one of the one or more outside walls, the radiation coupler being transmissive to radiation from the waveguide into the resonant cavity.

14. The device of claim 13, wherein the radiation coupler comprises a hole through the outside wall, the hole having a diameter smaller than a shortest wavelength of the band of wavelengths.

15. The device of claim 1, further comprising:
a radiation source operatively coupled to the waveguide, the radiation source configured to provide radiation to the waveguide;
a detector operatively coupled to the waveguide, the detector configured to receive radiation from the waveguide; and
a radiation circulator operatively coupled to the radiation source, the waveguide, and the receiver, the radiation circulator configured to (i) receive radiation from the radiation source, (ii) provide radiation to the waveguide, (iii) receive radiation from the waveguide, and (iv) provide radiation to the detector.

16. A method for performing flow measurement of a fluid, the method comprising:
disposing, in a fluid, a device according to claim 1;
providing fluid pressure against the deformable membrane;
providing, from a radiation source, radiation to the resonant cavity at a resonant frequency;
detecting, by a radiation detector, radiation from the resonant cavity;
determining, by a processor, a change in the resonant frequency of the resonant cavity; and
determining, by the processor, a fluid property from the change in the resonant frequency.

17. The method of claim 16, wherein the fluid property comprises at least one of a fluid flow velocity, a fluid temperature, a hydrostatic pressure, a fluid fill amount in a vessel, a pressurization amount of the fluid, or fluid density.

18. The method of claim 16, wherein providing radiation to the resonant cavity comprises:
providing, by the radiation source, radiation to the waveguide, the waveguide being operatively coupled to the radiation source and the resonant cavity; and
providing, by the waveguide, the radiation to the resonant cavity.

19. The method of claim 16, wherein the deformable membrane comprises a circular sheet of metal having a thickness of between 1 and 20 mil.

20. The method of claim 16, wherein the deformable membrane comprises a material selected from the group consisting of brass, stainless steel, and Inconel® alloy or alloys.
